(19) United States
(12) Patent Application Publication
(10) Pub. No.: US 2004/0068065 A1
(43) Pub. Date: Apr. 8, 2004

(54) Bonding to polymeric surfaces

(76) Inventors: Alexander Seifalian, London (GB); Henryk Salacinski, London (GB)

Correspondence Address: Nixon & Vanderhye, 8th Floor, 1100 North Glebe Road, Arlington, VA, 22201-4714, US

(21) Appl. No.: 10/344,323

(22) PCT Filed: Aug. 10, 2001
(86) PCT No.: PCT/GB01/03606

(51) Int. Cl. C08F 4/44

(52) U.S. Cl. 526/160

(57) ABSTRACT

The present invention relates to the use of ruthenium and osmium complexes as catalysts, preferably for bonding peptides to the surfaces of polymers, especially polymers for use as prosthetic materials in surgery, such as polymers for use as blood vessel grafts.

### FIELD OF THE INVENTION

The present invention relates to the use of ruthenium and osmium complexes as catalysts, preferably for bonding peptides to the surfaces of polymers, especially polymers for use as prosthetic materials in surgery, such as polymers for use as blood vessel grafts.

### BACKGROUND OF THE INVENTION

Atherosclerotic vascular disease in the form of coronary artery and peripheral vascular disease is the largest cause of mortality in both the United States and Europe. Surgical mainstays of therapy for affected vessels include bypass grafting with autologous veins or arteries; however, adequate autologous vein is lacking in many patients. Prosthetic vascular grafts are therefore required.

Several materials are presently available for use as prosthetic vascular grafts and other surgical prostheses. These include polytetrafluoroethylene (PTFE) and Dacron. These two materials are rigid and when used as grafts create a compliance mismatch at the anastomosis. The primary patency rates of PTFE or Dacron grafts is 20 to 30% at 4 to 5 years. A further material which can be used as a vascular graft is poly(carbonate-urea) urethane (CPU). This material has the advantage that it is more elastic and therefore more similar to the blood vessel which it is to mimic. CPU grafts are thus compliant grafts in the sense that they behave in a similar way to a natural blood vessel in the body. In particular, they flex more readily than PTFE or Dacron grafts when the site at which they are contained flexes.

Compliance is regarded by many as the key attribute required for matching cardiovascular prostheses to the arterial tree. The development of a compliant material is therefore thought to be an important step towards the improvement of clinical performance of small diameter grafts, particularly in low flow situations such as below knee arterial bypass. Obtaining long term compliance has been an elusive goal as currently used grafts rely on an overall external dilation to provide compliancy. However, perivascular ingrowth prevents external dilation and thus compliancy is lost after a relatively short period of time.

CPU based grafts however achieve compliancy via a different mechanism. Increases in volume are accommodated by a mechanism of wall compression without the need for external dilation. The use of compliant CPU rather than a more rigid material has previously been found to increase the patency rate of the graft (Seifalian et al, Tissue Engineering of Vascular Prosthetic Grafts, 1999 R. G. Landes).

However, the use of any of these materials alone for the graft is problematic: as the blood flows through the graft, particles such as platelets tend to adhere to the surface of the graft or the blood may coagulate, in particular in the area of the anastomoses, in particular the distal anastornisis, but also along the lurninal surface of the graft. This causes a narrowing (stenosis) in the inner diameter of the vessel, which is particularly problematic in the context of grafts of low diameter (for example 5 mm or less) where there is little blood flow. The major area which is effected is the distal anastomosis, where the downstream end of the graft meets the blood vessel. This has mainly been attributed to the lack of coverage by endothelial cells, the natural lining of normal blood vessels. The endothelium has the potential to release anticoagulant and platelet active substances which facilitate normal blood flow.

In order to address this problem, seeding grafts with endothelial cells, both before and during surgery, has been attempted. Broadly, seeding is carried out by extracting endothelial cells from the patient's adipose tissue or a vein and using these cells to coat the inside of the graft, in order to mimic the natural endothelium. Although seeding the graft in this manner has been shown to increase the patency rate, seeded cells adhere very poorly to the graft surface, in particular to PTFE. Indeed, where cells are seeded directly onto the graft lumen, only 1 to 14% of cells remain attached following exposure to blood flow.

Of crucial importance therefore in endothelial seeding is the ability of the seeded cells to resist the shear stress caused by the flow of blood through the vessel. The pulsatile nature of the blood flow makes it particularly likely that the cells will be swept away if not firmly attached to the surface of the graft. Where endothelial seeding is more difficult, e.g. with PTFE, the effect of shear stress is vital, although it is very important when using any graft material.

A reliable process of bonding cells to the graft is therefore required. The requirements for an ideal bonding process are the use of mild conditions and aqueous media only, and applicability to all important graft polymers. Further, the process should not involve toxic materials or interfere with sterilisation. The most desirable processes will additionally have the potential to be easily scaled-up for mass manufacture. The bonding of the cells to the graft has previously been enhanced by coating the graft luminal surface with an adhesive residue such as water-soluble fibronectin. However, such adhesive residues are very easily washed off with the endothelial cells when exposed to blood flow. Alternative methods include bonding chemical spacer arms to the polymer which forms the graft and then bonding the cells to the spacer arms.

The bonding of the spacer arm to the graft has previously been achieved using ceric (cerium IV) ion chemistry. This type of process involves the use of ceric ions as oxidants and involves bubbling oxygen through the graft material and thus generating oxygen radicals. However, the presence of oxygen radicals has been shown to alter the structure of the polymeric graft material. In vitro studies have shown that hydroxyl radicals cause oxidative degradation, which often leads to stress cracking and complete failure of the graft, in particular with grafts made from poly(ether)urethanes.

For surgical use, the acceptable scope for variation in the physical and chemical properties of the graft is small, and the change brought about by the oxygen radicals is sufficient to cause failure of the graft. In practice, graft failure has been shown to occur in an unacceptably high number of cases when ceric ion chemistry is used in the bonding process. Further, when compliant polymers such as CPU are used, the reaction step involving ceric ions and oxygen radicals causes many polyurethanes to become brittle, thereby diminishing the advantages of using such a material and significantly reducing compliance. Another disadvantage of this process is that ceric ions are toxic to humans. Their use is therefore highly undesirable in a medical context.

A new bonding technique is therefore required which provides an efficient way of bonding the spacer arm to the polymeric graft material, and which avoids damage to the structure of the graft material. It is also desirable to avoid entirely the use of ceric ions in the bonding process to avoid toxicity.

### SUMMARY OF THE INVENTION

Surprisingly, the inventors have found that a type of catalyst previously known only for use in non-medical fields, for example in catalytic converters and in the areas of non-linear optics and semiconductors, can be used in the attachment of spacer arms to polymeric materials such as those used in prostheses, in particular in vascular grafts. These catalysts are ruthenium or osmium based complexes which contain a cyclopentadienyl ligand. Such compounds facilitate electron-transfer type reactions. The present inventors have found that this type of chemistry may be adapted for use in bonding spacer arms to polymeric materials for use in surgical devices such as prostheses, notably vascular grafts.

The invention therefore provides an entirely new technique by which the spacer arms can be attached to the graft material. The use of ceric ions and oxygen radicals is completely avoided. Thus, the structural change to the graft material caused by the oxygen radicals is avoided and the patency rate of the graft is increased. This is particularly advantageous when using CPU as the graft material, since the structure remains essentially unaltered during the reaction using the ruthenium or osmium complexes and maintains its beneficial compliant properties. Further, the process of the invention enables some cross-linking to occur in the carbonate structure, thus making the material more stable and so virtually non-degradable.

However, the process is applicable to other graft materials. Moreover, the process of the present invention is relatively inexpensive, utilises mild conditions and can be carried out in aqueous media. It also avoids the toxicity problems caused by the use of ceric ions.

The use of mild, aqueous conditions results in an inherent hydrophilicity of the graft surface. This in turn provides a passivated substrate surface which dramatically reduces surface protein adsorption and cellular adhesion. This latent hydrophilicity also helps to retain the necessary bioactivity of the molecules attached because the length and three-dimensional mobility of the spacer arms allows these moieties to directly interact with cellular and physiological receptors.

Vascular grafts produced using this new attachment process are advantageous in that they can be used to replace small, medium and large calibre arteries and are suitable for peripheral vascular surgery and coronary bypass surgery. Such grafts provide an improved, synthetic blood-flow passageway since the luminal surface has a reduced thrombogenic nature.

In carrying out this work, the inventors have synthesised a particular catalyst which is useful for the present invention. This complex, which has the chemical formula Ru(Cp)(PPh₃)₂Cl (where Cp represents an unsubstituted cyclopentadienyl ligand), has been found to have a novel crystal structure. Its structure is novel in that it has a space group not previously known for this compound. The complex of this aspect of the invention was, additionally, prepared by a novel synthetic route. It appears that this process is responsible for the novel structure of the complex. Therefore, the novel process may be applicable to the production of other complexes with space groups equivalent to that of the complex of the invention.

Accordingly, the present invention provides:

A process for producing an activated polymer, which process comprises bonding a spacer arm to a polymer, characterised in that the process is conducted in the presence of a metallocene-type compound.

A process for catalysing a reaction using a metallocene-type compound, characterised in that the reaction comprises bonding a spacer arm to a polymer.

A process according to one of the two processes defined above wherein the metallocene-type compound is either a compound of formula:

M(Cp)L₂(Hal) (I)

wherein Cp is a cyclopentadienyl ligand which is unsubstituted or substituted by one or more substituents selected from halogen, hydroxy, nitro, C₁₋₆ alkyl, C₂₋₆ alkenyl, C₁₋₆ alkoxy, C₆₋₁₀ aryl, C₁₋₆ alkyl-C₆₋₁₀ aryl, C₂₋₆ alkenyl-C₆₋₁₀ aryl, —NR¹R², wherein R¹ and R² may be identical or different and are selected from hydrogen and a C₁₋₆ alkyl group, —COR³ and —COOR³ wherein R³ is hydrogen or a C₁₋₆ alkyl group;

M is ruthenium or osmium;

Hal is fluorine, chlorine, bromine or iodine;

the groups L may be identical or different and are selected from a C₁₋₆ alkyl group, CO and PR₃, wherein at least one L is PR₃;

the groups R may be identical or different and each is selected from hydrogen, a C₁₋₆ alkyl group and an aryl group Ar which is a C₆₋₁₀ aryl group or a heteroaryl group, the heteroaryl group being a 5- or 6-membered ring containing at least one heteroatom selected from nitrogen, oxygen and sulfur, and wherein each R is unsubstituted or substituted by one or more substituents which may be identical or different, each being selected from halogen, hydroxy, nitro, C₁₋₆ alkyl, C₂₋₆ alkenyl, C₁₋₆alkoxy, —NR¹R², wherein R¹ and R² may be identical or different and are selected from hydrogen and a C₁₋₆ alkyl group, —COR³ and —COOR³ wherein R³ is hydrogen or a C₁₋₆ alkyl group;

or a compound of formula:

M(Cp)₂ (II)

wherein M is as defined above and the groups Cp may be identical or different and are as defined above.

An activated polymer, lined polymer or prosthesis obtainable by one of the processes defined above.

An activated polymer, lined polymer or prosthesis obtained by one of the processes defined above.

A method of treating a human or animal subject in need of the replacement of a body part, said method comprising replacing said body part with a prosthesis obtained or obtainable by one of the processes defined above.

Use of a catalyst which comprises a metallocene-type compound as defined above, in bonding spacer arms to a polymer suitable for use as a prosthesis.

Use of a metallocene-type compound as defined above, a spacer arm and a polymer suitable for use as a prosthesis, in the manufacture of a prosthesis for the replacement of a body part.

A compound of formula (I) as defined above having the space group P21/n.

Ru(cyclopentadienyl)(PPh₃)₂Cl having the structure set out in FIG. 1, and having the bond lengths:

Ru(1)-P(2)=2.3202 Å

Ru(1)-P(1)=2.3212 Å

Ru(1)-Cl(1)=2.4510 Å

Ru(1)-C(O)=1.8417 Å

and having the bond angles:

Cl(1)-Ru(1)—C(O)=121.50 Å

P(2)-Ru(1)-P(1)=101.57 Å

P(2)-Ru(1)-Cl(1)=90.24 Å

P(1)-Ru(1)-Cl(1)=91.70 Å

P(1)-Ru(1)-C(0)=121.51 Å

P(2)-Ru(1)-C(0)=122.33 Å.

wherein C(0) represents the centre of gravity of the cyclopentadienyl ring.

A process for producing a compound of formula:

M(Cp)(PR₃)₂Hal (III)

wherein M, Cp, PR₃ and Hal are as defined above and wherein the groups PR₃ are identical or different, or Ru(cyclopentadienyl)(PPh₃)Cl as defined above, which process comprises reacting from 1.8 to 2.5 parts by mole of PR₃ with 0.8 to 1.5 parts by mole of Ru(Hal)₃ and 0.8 to 1.5 parts by mole of cyclopentadiene in dry diethyl ether.

Ru(cyclopentadienyl)(PPh₃)₂Cl having the structure defined above, which is obtainable by said process.

Ru(cyclopentadienyl)(PPh₃)₂Cl having the structure defined above, which is obtained by said process.

### BRIEF DESCRIPTION OF THE DRAWINGS

FIG. 1 represents a structure of the complex Ru(cyclopentadienyl)(PPh₃)₂Cl;

FIG. 2 represents a flow circuit for use in lining the activated polymers and in testing the lined polymers of the invention.

FIGS. 3a, b and c show ESEM analysis of graft coated with RGD and heparin (a, mag×55; b, mag×220; c, mag×3500).

FIGS. 4a and b show TMA analysis of heparin and heparin/RGD coated grafts.

FIGS. 5a, b, c and d show DMA analysis of heparin and heparin/RGD coated grafts.

### DETAILED DESCRIPTION OF THE INVENTION

Ruthenium and Osmium Complexes:

Ruthenium and osmium cyclopentadienyl complexes are known for their efficiency in a variety of synthetic catalytic processes. For example, Trost et al describe the use of such complexes as catalysts for addition reactions of alkenes to form unsaturated ketones (1997, J. Am. Chem. Soc. 119:836-837). Further uses of these complexes are found in fields such as catalytic converters, semiconductors and non-linear optics (Long; Angew. Chem. Int. Ed. Engl. 34: 21-38). The activity of these complexes as catalysts is believed to be due to the efficient charge transfer mechanism between the metal donor and the organic acceptor.

There is substantial interest in this type of complex and research is currently being carried out in the areas of (i) generation of carbene complexes from aldehyde acetals (Grotjahn, D B. Et al. Organometallics.1996;15: pages 2860-2862) or allenylidene ligands; (ii) formation of C- and O-bonded enolates from a coordinated-keto phosphine (Rasley et al., Organometallics.1996;15: pages 2852-2854); (iii) reactivity of neutral vinylidene complexes (Braun et al., 1995, J. Am. Chem. Soc.117: pages 7291-7292 and Organometallics;1996;15: pages 40754077); (iv) synthesis of amino allenylidene complexes (Bruce et al., J. Chem. Soc. Chem.Commun; 1996; pageslOo9-1010); cycloaromatization of a cationic vinylidene-ene-yne precursor (Wang and Finn; J. Am. Chem. Soc. 1995; 117: pages 8045-8046) and cyclopropanation of deprotonated vinylidene complexes (Ting et al., J. Am. Chem. Soc. 1996;118: pages 6433-6444). However, their use in the medical field has not previously been reported.

The present inventors have now found that metallocene-type compounds, for example ruthenium or osmium cyclopentadienyl compounds are useful as catalysts in the process of the invention. Metallocene-type compounds are compounds comprising a transition metal and one, two or more substituted or unsubstituted cyclopentadiene ligands. Preferred metallocene-compounds for use in the present invention are the compounds of formula:

M(Cp)L₂(Hal) (I)

wherein Cp, M, L and Hal are as defined above, or compounds of formula:

M(Cp)₂ (II)

wherein M and Cp are as defined above. Particularly preferred compounds for use in the present invention are those of formula:

M(Cp)(PR₃)₂Hal (III)

wherein M, Cp, R and Hal are as defined above.

As used herein a C₁₋₆ alkyl group is typically a linear or branched or cyclic alkyl group or moiety containing from 1 to 6 carbon atoms (3 or more when branched or cyclic), for example methyl, ethyl, n-propyl, i-propyl, n-butyl, t-butyl, pentyl and hexyl. An alkyl group may be unsubstituted or substituted at any position, for example with one or more substituents selected from halogen, hydroxy, C₁₋₆ alkyl, C₂₋₆ alkenyl, C₁₋₆ alkoxy, —NR¹R², wherein R¹ and R², which may be identical or different, are selected from hydrogen and a C₁₋₆ alkyl group, —COR¹ and —COOR¹ wherein R¹ is hydrogen or a C₁₋₆ alkyl group.

A C₆₋₁₀ aryl group is typically a phenyl or naphthyl group, preferably a phenyl group. An aryl group may be unsubstituted or substituted at any position, for example with one or more substituents selected from halogen, hydroxy, nitro, C₁₋₆ alkyl, C₂₋₆ alkenyl, C₁₋₆ alkoxy, —NR¹R², wherein R¹ and R², which may be identical or different, are selected from hydrogen and a C₁₋₆ alkyl group, —COR1 and —COOR¹ wherein R¹ is hydrogen or a C₁₋₆ alkyl group.

A heteroaryl group is typically a 5- or 6-membered ring containing one, two, three or more heteroatoms selected from N, O and S. Typical examples of heteroaryl groups include pyridyl, pyrazinyl, pyrimidinyl, pyridazinyl, furanyl, thienyl, pyrazolidinyl, pyrrolyl and pyrazolyl groups, the most preferred heteroaryl group being pyridyl. A heteroaryl group may be unsubstituted or substituted at any position, for example with one or more substituents selected from halogen, hydroxy, nitro, C₁₋₆ alkyl, C₂₋₆ alkenyl, C₁₋₆ alkoxy, —NR¹R², wherein R¹ and R², which may be identical or different, are selected from hydrogen and a C₁₋₆ alkyl group, —COR¹ and —COOR¹ wherein R¹ is hydrogen or a C₁₋₆ alkyl group.

A C₂₋₆ alkenyl group is straight, or branched or cyclic (when 3 carbons or more are present) and is typically an ethenyl, propenyl or butenyl group. An alkenyl group may be unsubstituted or substituted at any position, for example with one or more substituents selected from halogen, hydroxy, nitro, C₁₋₆ alkyl, C₂₋₆ alkenyl, C₁₋₆ alkoxy, —NR¹R², wherein R¹ and R², which may be identical or different, are selected from hydrogen and a C₁₋₆ alkyl group, —COR¹ and —COOR¹ wherein R¹ is hydrogen or a C₁₋₆ alkyl group.

A C₁₋₆ alkoxy group is straight, or branched or cyclic (when 3 carbons or more are present) and is typically a methoxy, ethoxy, propoxy or butoxy group. An alkoxy group may be unsubstituted or substituted at any position, for example with one or more substituents selected from halogen, hydroxy, nitro, C₁₋₆ alkyl, C₂₋₆ alkenyl, C₁₋₆ alkoxy, —NR¹R², wherein R¹ and R², which may be identical or different, are selected from hydrogen and a C₁₋₆ alkyl group, —COR¹ and —COOR¹ wherein R¹ is hydrogen or a C₁₋₆ alkyl group.

A halogen is typically fluorine, chlorine, bromine or iodine.

In the compounds of formula (I) and formula (II), the metal M is ruthenium or osmium and is preferably ruthenium. M is typically in the (I) oxidation state.

Typically, Cp is a cyclopentadienyl group which is unsubstituted or substituted with one or more, for instance two substituents. The cyclopentadienyl group is preferably unsubstituted or substituted with a methyl group, more preferably it is unsubstituted.

The cyclopentadienyl group may be bonded to the metal via an η¹ or η⁵ bond, preferably via an η⁵ bond.

Typically, in the compounds of formula (I), Hal is chlorine or bromine, preferably chlorine.

Typically, both groups L are represented by PR₃ wherein the groups PR₃, which may be identical or different, are represented by the formulae PR′₃, PR′₂Ar, PR′Ar₂, or PAr₃, wherein each R′, which may be identical or different, represents a C₁₋₆ alkyl group and each Ar, which may be identical or different, represents a phenyl, naphthyl or pyridyl group, each R¹ and Ar being unsubstituted or substituted with one or more substituents selected from halogen, hydroxy, nitro, C₁₋₆ alkyl, C₂₋₆ alkenyl, C₁₋₆ alkoxy, —NR¹R², wherein R¹ and R², which may be identical or different, are selected from hydrogen and a C₁₋₆ alkyl group, —COR³ and —COOR³ wherein R³ is hydrogen or a C₁₋₆ alkyl group. The groups R′ and Ar are preferably unsubstituted or substituted with a halogen, hydroxy, methyl, ethyl or methoxy group.

Preferably, the groups R′ and Ar in the formulae PR′₃, PR′₂Ar, PR′Ar₂ and PAr₃ are represented by methyl and phenyl groups respectively. The most preferred group PR₃ is PPh₃.

The most preferred compound of formula (I) is Ru(cyclopentadienyl)(PPh₃)₂Cl.

The ruthenium and osmium cyclopentadienyl complexes described above may be produced by any techniques known in the art. For example, M(Hal)₃ may be combined with unsubstituted or substituted cyclopentadiene, together with the ligands L to produce a comopund of formula (I). Suitable techniques include those described by Bruce et al (Aust. J. Chem. 1977, 30:pages 1601-1604; and J. Chem. Soc. Dalton Trans. 1981:pages 1398-1408). The compounds of formula (II) may be produced by combining M(Hal)₃ with two equivalents of substituted or unsubstituted cyclopentadiene.

Production of Activated Polymer:

The process of the present invention can be applied to any polymer which is suitable for use as a prosthesis. It can also be applied to a catheter or other surgical device which requires heparinising, such as by-pass tubing. Preferable polymers are those suitable for use as a prosthesis, in particular those suitable for use as a vascular graft such as polytetrafluoroethylene (PTFE), Dacron and poly(carbonate-urea)urethane (CPU). PTFE and Dacron are well-known materials, which are currently on the market for use in vascular grafts and are both rigid, non-compliant materials. CPU is a compliant material and is therefore preferred in the production of vascular grafts. The method of production of CPU is described in EP-A-0286220. Alternative polymers which can be used in the process of the present invention include polycarbonate urethane, polyester polyurethane, polyether urethane, nylon (arnorphous), polyester terephthalate, natural rubber, ethylene vinyl acetate, styrene butadiene rubber, fluoroelastomers, polychloroprene, polyhexene, acrylonitrile-butadiene, ethylene vinyl acetate, polyvinylchloride, silicone rubber copol, polyisoprene, silicone rubber and butyl rubber.

The activation process may be carried out using a polymer in any form. Specifically, the polymer may be a flat sheet or a tube, or may be pre-formed into the form of a prosthesis, catheter or other device.

Any spacer arms known in the art may be used for the purposes of the present invention. Suitable spacer arms are described by Bamford et al (Clinical Methods, 1992; 10: pages 243 to 261) and the references cited therein, which documents are incorporated herein by reference. Examples of suitable spacer arms include nitrogen containing compounds, peptides and alcohols. Examples of nitrogen-containing compounds include amines (for example primary, secondary and tertiary amines), quaternary ammonium compounds and amides. Particularly preferred nitrogen containing compounds are N-(3-aminopropyl)-methacrylamide hydrochloride (AMPA), 6-aminohexanoic acid and acrylamide. Examples of peptides are short to mid-length peptide sequences, for example the glycyl residue, pentaglycine, di-beta-alanine, primaquine-peptides and Gly-betaAla-betaAla. Examples of alcohols are polyethylene glycol and bis(aminohexanyol).

When the moiety to be attached to the spacer arm is a growth factor, the spacer arm preferably has a rigid structure. Due to its relatively low flexibility, acrylamide is a particularly preferred spacer arm for use in attaching growth factors to the graft.

The bonding process is carried out by optionally pre-treating the polymer, followed by reaction of the optionally pre-treated polymer with the catalyst and the spacer arm under inert conditions, typically under a nitrogen atmosphere. Typically, the reaction is carried out in distilled water, preferably at a temperature of 30 to 45° C., preferably 35 to 40° C., more preferably 37° C. The reaction is preferably carried out at a pH of below 7, for example from 5 to 7 or from 6 to 7. In order to adjust the pH, an acid, for example a common mineral acid such as nitric acid, may be used.

The catalyst used comprises one or more metallocene-type compounds, preferably one or more ruthenium or osmium complexes as described above.

Desirably, the activation reaction is carried out in the presence of a conjugating agent in order to reduce the amount of gel formed during the reaction and to facilitate the removal of any gel which does form. This gel is thought to be the product of cross-linking reactions between spacer arms. Any conjugating agent which is well-known in the art may be used. For example, ammonium salts may be used. A preferred conjugating agent is 1,1-dimethyl-1-(3-methacrylamidopropyl)-1-(3-sulphopropyl)ammonium betaine (SPE).

The pre-treatment step is preferably carried out using a surface activating agent. Any surface activating agent known in the art may be used, for example 4,4 azo bis (4-cyano valeric acid). The temperature at which the pre-treatment is carried out is preferably from 10 to 90° C., more preferably 25 to 75° C., most preferably at 50° C.

The result of the activation reaction is a polymer having spacer arms bound thereto, hereafter referred to as ‘activated polymer’.

The activated polymer of the invention is optionally formed into the shape of a surgical device, for example into a prosthesis. Alternatively, the activated polymer may be lined with a lining substance before being formed into the shape of a surgical device, for example into a prosthesis.

Production of Lined Polymer:

The present invention further provides a process for producing a lined polymer which comprises reacting the activated polymer, which is optionally in the form of a prosthesis, with a lining substance. Suitable lining substances include cells or peptides, for example anticoagulant peptides, growth peptides or chemotactic peptides, in particular anticoagulant peptides or growth peptides, especially heparin and/or RDG (Arg-Gly-Asp).

The cells which can be used in the present invention include endothelial cells and microvascular cells, preferably endothelial cells. Examples of suitable cells include animal cells, such as animal endothelial cells, or cells which have been harvested from the human vein, typically the saphenous vein or the umbilical vein or from human adipose tissue. Cells are harvested using standard techniques such as those described by Jaffe et al (J. Clin. Invest. 1973; 52; 2745-56). Seeding such cells on the inside surface of a vascular graft is known to encourage the growth of the full endothelium. This provides a natural defence against particles adhering to the surface of the graft and increases the patency rate. Typically the cells used are derived from the patient's own tissue to avoid rejection.

Examples of anticoagulant peptides which can be used as a lining substance include any anticoagulant peptide known in the art, such as apolipoprotein B-100 and KRAD-14 peptide. The KRAD-14 peptide is derived from apolipoprotein B-100 and has the formula:

Z¹-K-A-Q-X′-K-K-N-K-H—R—H—S—X²-T-Z²

where:

X¹ represents S or Y,

X² represents T or I,

Z¹ represents the N terminus of the peptide, or from 1 to 47 amino acids,

Z² represents the C terminus of the peptide, a terminal amide group, or from 1 to 77 amino acids. In this formula the peptide sequence is represented by the standard 1-letter code.

It is suggested in the art that this peptide has an inhibitory effect against prothrombinase complex (factor Xa and factor V) in activating thrombin. The KRAD-14 peptide also has an ability to prevent the activation factor VII on the surface of thromboplastin. Furthermore, the KRAD-14 peptide seems to affect the activation of platelets by thrombin, probably due to prevention of the activation of thrombin. However, direct effect of KRAD-14 peptide on platelet activation cannot be ruled out.

Variants of the KRAD-14 peptide which contain one or more internal deletions, insertions or substitutions and which substantially retain anti-coagulant properties equivalent to apolipoprotein B-100, as well as the salts of the KRAD-14 peptide or its variants, are also suitable for use as anticoagulant peptides in the present invention.

It is also known in the art that, within apolipoprotein B-100, the domain including KRAD-98 and KRAD-14 (amino acids 3121-3217) is structurally closely associated with another positively charged sequence, in the region of amino acids 3300-3400. More specifically, the positively charged sequence is believed to be RLTRKRGLKLAT, which is the sequence of amino acids 3359-3367 of apolipoprotein B-100. Therefore, this sequence may be able to enhance the activity of the peptides of KRAD-14.

It is therefore possible, in the process of the present invention, to use as an anticoagulant a combination of KRAD-14 and a second peptide which comprises amino acids 3300-3400 of apolipoprotein B-100, or apart or variant of this sequence. The two peptides may be physically attached in any way. For example, the second peptide may be provided as an N-terminal or C-terminal extension of the KRAD-14 peptide, joined by a peptide bond, or it may be attached in some other way, for example by one or more covalent linkages, such as cysteine-cysteine disulphide linkages. The attachment can be made by means known in the art. Further details regarding the KRAD-14 peptide and this combination of peptides, and their use as anticoagulants, can be found in WO97/4331.

Lining the polymer with an anticoagulant peptide such as those mentioned above has the advantage that, when a prosthesis formed from such a polymer is inserted into a patient, the anticoagulant effect is immediate. This is in contrast with the lining of the polymer with seed cells, since it takes some time for a full endothelial layer to form from the relatively few endothelial cells that adhere to the polymer surface during seeding.

Examples of suitable growth peptides for use as a lining substance include any peptides known in the art to encourage the growth of the endothelial layer. Typical growth peptides are ARG-GLY-ASP, fibronectin fragments 1371-1382 and 1377-1388, for example as described by Mohri, H et al (Peptides.1995, 16: page 263), fibronectin adhesion promoting peptide, for example as described by Woods, A., et. al. (Mol. Biol. Cell, 1993; 4: page 605), GLY-ARG-GLY-ASP, for example as described by Haverstick, DM. et. al. (Blood; 1985; 66: page 946).

Examples of suitable chemotactic peptides are those which attract endothelial cells to the surface to which they are attached, in the case of vascular grafts, the lumen of the graft. N-Formyl peptides are suitable for these purposes as they secrete chemoattractants which direct the migration of cells to the chemoattractant source. Fibronectin fragments and related peptides can also be used. These proteins promote adhesion of endothelial cells to the graft lumen and also to other cells. They also help to stabilise clot formation. Further details regarding chemotactic proteins can be found in Freer R J., et al. 1979; Peptides, structure and biological function; Proceedings of the sixth American peptide symposium; Gross, E and Meienhofer, M., eds749 and Procter, R, A; Rev. Infect. Dis. 1987; 9: page 317.

In the process of producing a lined polymer, it is preferred that two or more lining substances are used. Thus, two different types of seed cells can be used, or, more preferably, the lining substance comprises both seed cells and peptide. For example, the lining substance may comprise seed cells and anticoagulant peptide. This has the advantage that immediate anticoagulant effect is provided by the peptide whilst the endothelial layer itself is still not fully formed. Alternatively, the lining substance may comprise seed cells and growth peptide. In this case the formation of the endothelium from the seeded cells is expedited by the presence of growth peptide. A preferred lining substance comprises seed cell, anticoagulant peptide and growth peptide.

The process of lining the polymer with the lining substance may be carried out by any technique known in the art. Typically, the lining substance is suspended in a suitable medium. When cells are present in the lining substance, these may be cultivated by any standard cultivation technique such as that described by Zilla et al (J. Vasc. Surg. 1990; 12: pages 180-9). In this case, the medium in which the lining substance is suspended is typically a tissue culture medium. The concentration of cells in the tissue culture medium is preferably from 1 to 50×10⁵ cells/cm², preferably from 2 to 24×10⁵ cells/cm², more preferably from 2 to 16×10⁵ cells/cm². Other suitable media which can be used include whole blood or distilled, deionized water which has been autoclaved and filtered to ensure sterility. The concentration of peptides in the medium is preferably in the region of 1 ng to 100 μg per ml of medium, preferably from 100 ng tol 1 g per ml of medium.

The lining substance may then optionally be functionalised. This is a preparation step which provides conditions in which the spacer arm may be better able to bind. This in turn leads to the stabilisation of the lining substance once it has been covalently linked to the spacer arms. Suitable agents for carrying out this step include carbodiimides. The carbodiimide may be unsubstituted or substituted at one or two positions. Examples of suitable substituents include C₁₋₆ alkyl groups, C₂₋₆ alkenyl groups, hydroxy groups, halogens, and amino, mono(C₁₋₆alkyl)amino and di(C₁₋₆alkyl)amino groups. Each of the alkyl and alkenyl groups of these substituents may be unsubstituted or substituted at any position with one or more further substituents. Suitable further substituents include hydroxy groups, halogens, and amino, mono(C₁₋₆alkyl)amino and di(C₁₋₆alkyl)amino groups, preferably amino, mono(C₁₋₆alkyl)amino and di(C₁₋₆alkyl)amino groups.

Preferred agents for carrying out the functionalisation include carbodiimides substituted with one or two groups selected from C₁₋₆alkyl groups, amino(C₁₋₆alkyl) groups, C₁₋₆alkylamino (C₁₋₆alkyl) groups and di(C₁₋₆alkyl)amino(C₁₋₆alkyl) groups. Particularly preferred agents include 1-(C₁₋₆alkyl)-3-amino(C₁₋₆alkyl)carbodiimides, 1-(C₁₋₆alkyl)-3-(C₁₋₆alkyl)amino(C₁₋₆alkyl)carbodiimides and 1-(C₁₋₆alkyl)-3-di(C₁₋₆alkyl)amino(C₁₋₆alkyl)carbodiimides. A particularly preferred agent is 1-ethyl-3 (3-dimethylaminopropyl)carbodiimide (EDC).

The medium comprising the optionally functionalised lining substance dissolved or suspended therein, is then contacted with the activated polymer. Typically, the medium is either inserted into a chamber containing the activated polymer and incubated for a period of 0.1 to 10 hours, preferably 0.5 to 6 hours, or the medium is pumped over the activated polymer for a period of 0.05 to 10 hours, preferably 0.5 to 6 hours. When the polymer is a tubular polymer, it may be rotated during incubation or pumping in order to obtain a more even lining of the polymer. The incubation or pumping procedure may be repeated one or more times to improve the seeding efficiency of the cells or coverage of the surface with peptides. The process is preferably carried out at a temperature of 30 to 45° C., preferably 35 to 40° C., more preferably 37° C. If cells are present in the lining substance, it is particularly important for the process to be carried out at about 37° C.

In order to enhance the adhesion of lining substance to the polymer, electrostatic charges may be applied to the polymer or 0.5 Tesla Helmholz coils may be used, for example before or during the incubation or pumping process.

The bonding of the lining substance to the spacer arms can be achieved most efficiently when the spacer arms are bound to the polymer with a regular orientation. Desirably, for bonding of cells or peptides of the lining substance to the polymer, the spacer arm should be correctly placed. When rigid polymers such as PTFE or Dacron are used, the bonding of the spacer arms is fairly uniform. However, with compliant polymers such as CPU, the orientation of the spacer arms on bonding to the polymer is far less regular and it becomes particularly difficult for the lining substance to bind. The proportion of the lining substance which bonds to the spacer arms is generally low and it is therefore particularly desirable to address this problem.

One manner in which this can be done is by applying a hydrogel to the luminal surface of the activated polymer. It has previously been shown that when in solution, the spacer arms are more likely to have the correct orientation to enable the lining substance to bind. Application of a hydrogel to the polymer, e.g. after the lining substance has been added to the activated polymer, creates a localised, solution-like, aqueous environment around the spacer arms on the activated polymer and encourages them to take up a uniform orientation. Thus, the proportion of lining substance particles which binds is increased.

Further Processing of Lined/Activated Polymer:

The polymer may be in the form of a prosthesis or other device such as a catheter or tubing for use, for example, in by-pass operations. Alternatively, the activated or lined polymer may be formed into a suitable device after the activation step or after both the activation and the lining steps. The formation of the prosthesis or other device may be carried out by any technique known in the art. For example, the technique described by Edwards, A., et al (J. Biomat. App.1995; 10: pages 171-187) may be used.

Typically, the activated and lined polymers of the invention are used to form prostheses, such as vascular grafts, heart valves, stents, conduits for use in surgery to correct nerve damage and orthopaedic joint replacements. Preferred prostheses are vascular grafts.

The activated and lined polymers of the invention may also be envisaged for use in surgical devices other than prostheses. Examples include devices which need to be heparinised, such as catheters, plastic tubing through which blood is passed during by-pass operations and tubes used for injecting labelling substances such as In for use in X-ray diagnosis techniques. When the activated polymers of the invention are used in such a manner, the lining substance is typically heparin.

The lined polymers of the present invention, when in the form of a prosthesis, may be used in the treatment of a human or animal subject in need of the replacement of a body part, said method comprising replacing said body part with a prosthesis of the invention. Said method may be carried out using standard techniques known in the art of prosthetic surgery. For example, where the prosthesis is a vascular graft, the graft may be anastomosed to the natural blood vessel in an end-to-end, end-to-side, or side-to-side manner. The anastomosis is typically carried out using sutures. However, when sutures are used, the anastomosis is normally rigid, even when the graft is formed from a compliant polymer such as CPU. Maintaining compliance at the anastomoses, especially the distal anastomosis, is particularly important since this is the most likely site for stenosis to occur. Alternative methods have therefore been developed such as the use of clips or laser techniques. An advantage of these techniques is that they retain some of the compliant nature of the graft at the anastomoses.

Novel Structure of Ruthenium Complex:

The present inventors, in devising the invention, have found a new crystal structure for the known compound Ru(cyclopentadienyl)(PPh₃)₂Cl. This compound was first reported by Gilbert and Wilkinson (J. Chem. Soc. A. 1969: pages 1749-1753) and can be synthesised by the simple route described by Bruce et al (Aust. J. Chem. 1977; 30: pages 1602-1604). This route involves the rapid successive addition of ethanolic ruthenium trichloride and cyclopentadiene to triphenyl phospine in ethanol.

The structure of the previously produced compounds is triclinic with a P1/n space group (a=14.493(8), b=11.315(4), c=11.745(4)Å, α=69.99(3), β=84.67(4), γ=62.27(3); Z=2; Bruce et al, J. Chem. Soc. Dalton. Trans. 1981: pages 1398-1408).

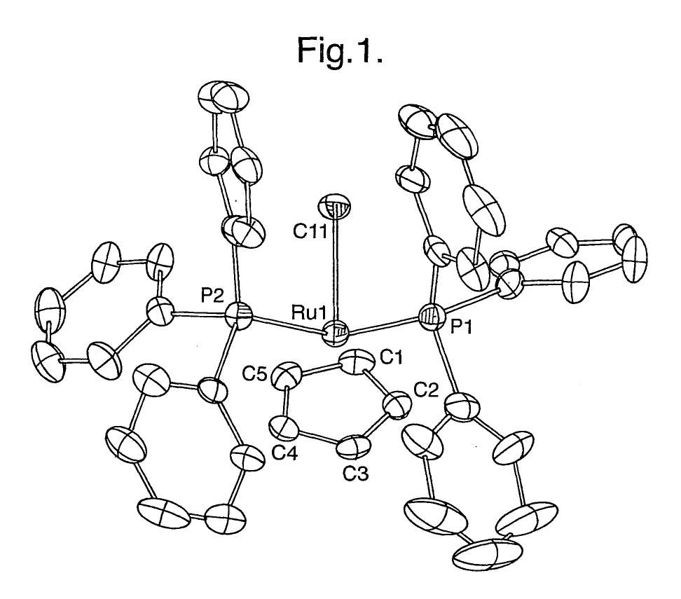

The present inventors have produced a compound having the same chemical formula, but a different crystal structure. The basic structure of the new compound is depicted in FIG. 1 and the bond lengths and bond angles are defined above. The new compound is isomorphous with the previously known compound, but has a new space group P21/n. The cyclopentadienyl ligand is bound to the ruthenium atom in a η⁵ manner. The geometry about the ruthenium atom in the new structure can be considered to be distorted octahedral, with the cyclopentadienyl ligand effectively taking up three coordinate positions. Alternatively, the geometry can be considered to be distorted tetrahedral, with the perpendicular axis of the cyclopentadienyl ligand (C(O)) being taken as occupying a single coordinate position.

The novel structure of the complex can be obtained using the synthetic process of the invention. The synthetic process may also be used to obtain other ruthenium and osmium complexes, such as the compounds of formula (I) which are used in the process for producing the activated polymers of the invention. Further complexes may be obtained by this route having the same structure as the novel compound of the invention. Thus, further compounds having novel crystal structures are envisaged.

The synthetic process of the invention may be used to produce compounds of formula:

MCp(PR₃)₂Hal (III)

wherein M, Cp, PR₃ and Hal are as defined above and the groups PR₃ may be identical or different. The process is carried out by reacting from 1.8 to 2.5, preferably from 1.9 to 2.3, more preferably 2.0 parts by mole PR₃ with from 0.8 to 1.5, preferably from 0.9 to 1.3, more preferably 1.0 parts by mole M(Hal)₃ and from 0.8 to 1.5, preferably from 0.9 to 1.3, more preferably 1.0 parts by mole cyclopentadiene, in dry diethyl ether. It has been found that carrying out the reaction in dry diethyl ether causes the complex to rearrange on crystallisation to the new structure.

The reaction is preferably carried out under inert conditions, for example under a nitrogen atmosphere. Typically, PR₃ is dissolved or suspended in dry diethyl ether and added to a solution of M(Hal)₃ in the same solvent, which has preferably been filtered. A solution of substituted or unsubstituted cyclopentadiene in the same solvent is added, either simultaneously with the PR₃, or, more preferably, after a period of 1 to 30 minutes, preferably 5 to 15 minutes, more preferably 10 minutes. The cyclopentadiene is preferably freshly distilled before being used. The reaction is preferably carried out at a temperature above room temperature, preferably between 20 and 80° C., more preferably between 40 and 60° C. When this process is used to produce a compound of formula RuCp(PPh₃)₂Cl, the reagents used are RuCl₃, PPh₃ and unsubstituted cyclopentadiene.

In order to obtain crystals of the complex produced, the resulting solution is evaporated to dryness, the residue dissolved in a polar organic solvent such as chloroform, dichloromethane, methanol, ethanol or ethyl acetate, preferably chloroform, and crystallisation is carried out by slowly diffusing a non-polar solvent into the solution. Suitable non-polar solvents include diethyl ether, tetrahydrofuran, hexane and petroleum, preferably hexane.

The structure of the resulting crystals can be determined using standard techniques, such as X-Ray crystallography by a powder diffraction method, or using a more precise least squares refinement.

The invention is described in more detail in the following Examples:

### EXAMPLES

### Example 1

### Synthesis of C₄₁H₃₅CIP₂Ru.C₂H₄O

Unless otherwise stated, the following procedure is carried out under a dry nitrogen atmosphere, following conventional Schlenk and vacuum techniques. All reagents used in this procedure were Analar or of chemically pure grade and all solvents were distilled from the appropriate drying agents and deoxygenated before use.

A filtered solution of hydrated ruthenium trichloride in dry diethyl ether was added to two equimolar amounts of stirred triphenylphosphine suspended in refluxing diethyl ether. After 10 min of refluxing, freshly distilled cyclopentadiene in diethyl either was added. The mixture was then refluxed with stirring for a further 3 hours until a complete colour change from brown to orange-red was observed. The solution was evaporated to dryness and the residue was dissolved in chloroform in a Schlenk tube. Orange-red prisms were obtained by slow diffusion (over period of several days) of hexane into the chloroform solution. The solution was removed from the Schlenk tube and the resulting crystals were collected in a yield of 90%.

The ¹H NMR spectrum (in CDCl₃) of the crystals contains a sharp singlet at about 4 p.p.m. (σ) for the C₅H₅ protons and a multiplet at about 7 p.p.m. for the aromatic protons. The ³¹P NMR spectrum in methylene chloride showed one sharp signal at 39 p.p.m. indicating that the two triphenylphosphine ligands were equivalent. The signal did not change within the −80 to 35° C. temperature range. The IR spectrum was obtained using a KBr pellet giving ν (Ru—Cl) 281 m, 276 m cm⁻¹. The molecular formula of the compound was confirmed by mass spectrometry using the FD technique M⁺ 726.

The structure of the complex obtained was determined by collection of X-ray diffraction data using an Enraf-Nonius CAD-4 circle diffractometer. The conditions of data collection were as follows:

| | |
|---|---|
| Enraf-Nonius CAD-4 four | [I > 2σ(I)] |
| circle diffractometer | ^{R}ᵢₙₜ = 0.0510 |
| 2θ/ω scan | ^{θ}ₘₐₓ = 24.97° |
| absorption correction | h = 0 → 16 |
| ψ-scan | k = 0 → 20 |
| ^{T}ₘᵢₙ = 0.928, ^{T}ₘₐₓ = 0.997 | l = −18 → 18 |
| (North, Phillips, & Matthews, 1968) | 3 standard reflections |
| 6767 measured reflections | Frequency: 60 min |
| 6480 independent reflections | intensity variation: <5% |
| 3270 observed reflections | |

The following crystal data was obtained:

| C₄₃H₃₉ C1 O P₂ Ru | |
|---|---|
| M_{Γ}= 770.20 | Mo Kαradiation |
| Monoclinic | λ = 0.71073 Å |
| P21/n | cell parameters from 25 reflections |
| a = 13.973(3) Å | θ = 10.0-14.0° |
| b = 17.001(3) Å | μ = 0.617 mm⁻¹ |
| c = 15.881(3) Å | Dₓ = 1.384 g/cm⁻³ |
| α = 90.00° | |
| β = 101.92(3)° | |
| γ = 90.00° | T = 290 (2) K |
| V = 3691.3(12) Å³ | prism |
| Z = 4 | 0.21 × 0.10 mm |

### Example 2

### Activation of CPU

An activated CPU polymer was prepared by inserting the poly(carbonate-urea) urethane (CPU) to be activated into distilled water maintained at a temperature of 50° C. 4,4,azo bis(4-cyano valeric acid) was added and the mixture stirred for 45 minutes. The polymer was then washed five times with fresh distilled water.

A mixture of (1,1-dimethyl-1-(3-methacrylamidopropyl)-1-(3-sulphopropyl)ammonium betaine (SPE), nitric acid, N-(3-aminopropyl)methacrylate hydrochloride (AMPA) and Ru(cyclopentadienyl)(PPh₃)₂Cl were then added to the polymer and reaction continued under dinitrogen for 4 hours at 37° C. After a further 45 minutes, the polymer was washed five times with fresh distilled water to yield the activated polymer.

### Example 3

### Lining with Peptides/Cells

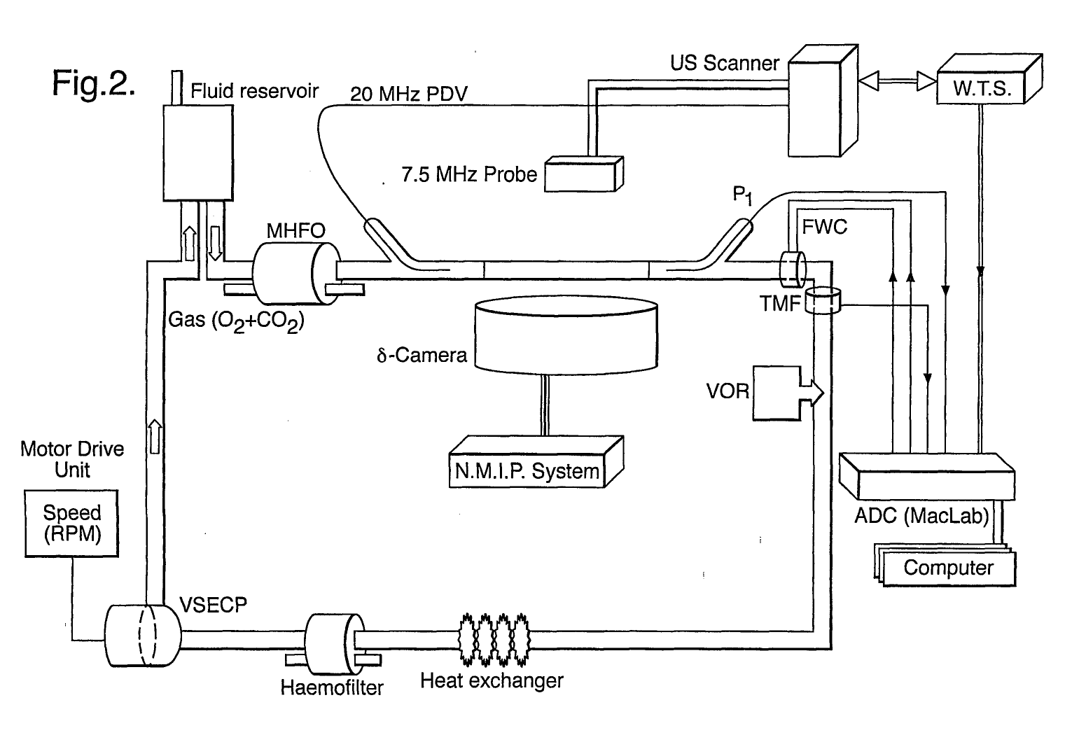

The activated polymers of the invention may be lined with peptides and cells using a flow circuit such as that depicted in FIG. 2 and described in more detail in Example 5 below. The flow circuit is also described by Guidiceandrea in J Artif Organs, 2000, 3:pages 16-24). The flow circuit comprises a fluid reservoir and a variable speed electromagnetic centrifugal pump (Bio Medicus) VSECP, which pumps the fluid around the system through flexible plastic tubing 2 and through the activated polymer placed at position 1. The fluid comprises culture solution and peptide which is pumped around the circuit for 2 hours. The system is then washed out with distilled water and dried.

Cells are then injected into the surface of the activated polymer and incubated statically for 30 minutes to produced a lined polymer.

### Example 4

### Lining with Heparin

5 to 10 g of heparin in 1 litre distilled water was added to a reaction vessel. 0.25 to 0.50 g of 1-ethyl-3(3-dimethylaminopropyl)carbodiimide (EDC) was added, together with sufficient HCl to provide a pH of from 4.5 to 6.5. Reaction was continued for 1 hour.

A section of CPU graft which had been activated in accordance with Example 2 was then perfused for 6 hours with this solution in a flow circuit as described in FIG. 2 and Examples 3 and 5. The lined graft was then washed by continuing perfusion first with distilled water and then with 0.01N NaOH solution.

Finally, the graft was dried in a CO₂ incubator and sterilised.

### Example 5

### In Vitro Tests

Prostheses composed of the lined polymers of the invention are tested in vitro by circulating blood through the specially designed flow circuit depicted in FIG. 2. This model system provides an accurate simulation of the haemodynamic forces within the blood circulation system in the body. The system is fitted with a Maxima hollow-fiber oxygenator (Johnson & Johnson) MHFO, which oxygenates the circulating blood with 95% air and 5% CO₂. The pH, pO₂ and pCO₂ are monitored at regular intervals with an automatic blood gas, electrolyte and haematocrit analyser (BG Electrolytes System) and corrections are made accordingly to ensure constant physiological values.

A flow waveform conditioner FWC fitted with an analogue digital converter ADC is used in conjunction with the flow system to produce a pulse of the desired waveform. As the blood flows through the grafts, various measurements can be taken. Specifically, the retention of In-labelled endothelial cells on the lined polymer is measured using a gamma camera, 8-camera, linked to a nuclear Medicine Image Processing System, NMIP, using a system which accurately mimics the shear stress conditions found in a blood vessel in the body. The section of the circuit containing the grafts 1 is positioned over the camera and images are acquired at regular periods during operation of the flow circuit. Spontaneous leakage is determined in a separate experiment and accounted for. Cell attachment can then be calculated with respect to time.

The effect of pulsatile flow on the metabolism and growth of seeded cells is also measured. This is achieved by comparing the endothelial cell coverage of lined polymers which have been perfused in the flow circuit for a period of 8 hours with a control of the same lined polymer which has not been tested in the flow circuit.

Similar in vitro tests can be envisaged for heart valves and other prostheses, as well as for non-prosthetic surgical apparatus, e.g. cannulas and tubing, comprising the lined polymers of the invention

### Example 6

### Analysis of Lined Polymers

Lined polymeric graft material was prepared by activating a sample of Myolink™ (University College London and CardioTech Ltd, Wrexham UK). The native graft is activated in accordance with Example 2 and the activated polymer lined with heparin, or with a mixture of heparin and RGD in accordance with standard techniques. RGD is a peptide having the sequence Arg-Gly-Asp which has been shown to promote cell adhesion and attachment.

The lined polymers were subjected to testing using the flow circuit described in FIG. 2. The table below (1) is a summary of flow data. Each lined polymer was perfused over a 10 hour period and then examined using the techniques described below.

TABLE 1
Summary of haemodynamic parameters.
Data presented as mean ± standard deviation.

| Input Parameters | | Computed Parameters | |
|---|---|---|---|
| Frequency of pulsatile cycle | 1 Hz | Inlet length (mm) | 55 |
| Temperature ° C. | 37° ± 1.1 | Peak Reynolds number | 516 |
| Mean flow ± SD (ml/min) | 209 ± 12 | Mean shear stress (dyn/cm²) | 7.51 ± 0.3 |
| Pressure (mmHg) | 120/60 | Peak shear stress (dyn/cm²) | 24.4 ± 0.7 |
| Ph | 7.3 ± 0.05 | Mean velocity ± SD (cm/sec) | 23.5 ± 1.0 |
| PO₂ (kPa) | 21 ± 1 | Wormersley parameter | 2.74 |
| pCO₂(kPa) of solution | 4.2 ± 0.3 | | |
| Viscosity of solution (poise) | 0.035 ± 0.2 | | |

Assessment of Bonding: Description of Techniques Used

1. X-Ray Photoelectron Spectroscopy (XPS)

Sample Preparation for XPS Study

Three small sectors of the lined polymer were fixed to the holder using small pieces of double-sided adhesive tape. An electrically grounded 90% transmission nickel mesh grid was placed a few millimetres above the sample surface to aid electrostatic charge compensation.

Narrow Beam Source XPS: Technique and Instrumentation

XPS measurements were performed with a Surface Science Instruments (SSI) M-Probe Spectrometer operating at a base pressure of 4×10⁻⁷ Pa (3×10⁻⁹) torr. The instrument energy scale is calibrated using the Au(4f_{7/2}) and Cu(2p_{3/2}) peaks at 83.98 and 932.67 eV respectively. For this instrument, the transmission is independent of binding energy. This is readily verified by measuring the predicted 2:1 ratio (66.6 at %: 33.4 at %) for fluorine: carbon for a fresh PTFE (Teflon) sample.

The samples were irradiated with monochromatic Al Kα X-rays (1486.6 eV) using an X-ray spot size of 1000 μm×400 μm and ˜180 W power. Survey spectra were recorded with a pass energy of 150 eV, from which the surface chemical compositions were determined. In addition, selected high-resolution spectra were recorded with a pass energy of 25 eV (Resolution 1) or 50 eV (Resolution 2), from which the chemical states of those elements were determined.

Charge compensation for electrically insulating specimens was achieved using a beam of −4 to 9 eV electrons at a flood gun current of —0.1 mA with an electrically grounded 90% transmission nickel mesh screen positioned ˜1 mm above the sample surfaces.

The standard electron take off angle used for analysis is 350 giving a maximum analysis depth lying in the range 3-5 nm.

Assessment of Degradation of Polymer After Bonding

2. Environmental Scanning Electron Microscopy (ESEM):

The ESEM micrographs were taken at 1.5 mm intervals along the grafts. The digital micrographs were “blind” examined for features indicating ESC such as fissuring, interlocking, cracking and surface grazing of the graft material.

3. Gel Permeation Chromatography (GPC):

A Varian DS-651 LC Star System with a type 9010 solvent delivery system and a type 9065 Polychrom® UV diode array was used to obtain chromatograms. The solvent used was tetrahydrofuran with a flow rate of 1 ml/min at 40° C. Cross-linked Polystyrene columns from PL-Gels, Polymer Laboratories with pore sizes of 500, 10⁴, and 10⁵ Å were used.

4. Thermo-analytical Methods

a) Differential Scanning Calorimetry (DSC):

DSC was performed using a Shimadzu DSC-50. The heat flux DSC-50 was operated with a cooling attachment from −150° C. to 150° C. to obtain thermo-grams of each material at a heating rate of 20° C./min using liquid nitrogen as the cooling agent. The temperature difference between the sample and reference was proportional to the difference in heat flow (from the furnace) between the two materials. The heat flux DSC-50 measures the exothermic and endothermic reactions of the sample and heat capacity in the constant rate heating, cooling and isothermal hold temperature formats. This provides a direct measure of the heat changes. These arise from changes in heat capacity arising from physical changes typically melting, phase and glass transitions. Samples (50 mg) were introduced in sealed aluminum sample pans. In order to improve the accuracy of the temperatures and enthalpies associated with the thermo-tropic transitions of the biodegraded samples, in particular the cell constant, all DSC experiments were conducted with the calorimeter calibrated with an indium standard. The glass transition temperature (T_{g}) was taken at the midpoint (1/2Δcₚ) of the stepwise increase in the heat capacity. The heat capacity was calibrated by running a standard sapphire (Al₂O₃) sample.

b) Thermo-Mechanical Analysis (TMA):

TMA was performed using a Shimadzu TMA-50. The TMA system was operated over the temperature range −120° C. to 280° C. and measured the deformation of the biodegraded sample whilst under a 50 g load and being linearly heated. Samples (50 mg) were introduced in sealed aluminum sample pans.

c) Dynamic Mechanical Thermal Analysis (DMA):

DMA was performed using a Rheometric Scientific DMTA III. DMA quantitatively measures mechanical behavior as a function of temperature, frequency and stress over the temperature range −150° C. to 150° C. It is a sensitive technique, particularly for determining glass transition temperatures (T_{g}) which give rise to a pronounced maximum in tan delta (damping) in a dynamic mechanical environment. The DMTA III provided bending, shear, tension and compression data at a frequency of 1 Hz and a strain range of 15 m to 15 m at F=0.1N. Samples (50 mg) were introduced in sealed aluminum sample pans.

5. Quality Control Post Bonding

Measurement of the effects, if any, on dimensional characteristics: internal diameter; wall thickness and visual examination were performed according to ISO standard operating procedures. The internal diameter of the grafts was measured using a calibrated taper gauge. The latter was performed to the international standards organization certification standard: 8.5-ISO/DS7198/40/. Measurements of graft wall thickness were performed with a constant load gauge, to the following international standards organization certification standard 8.7-ISO/DS7198 and a visual assessment made with white light back illumination, to the following international standards organization certification standard 8.1-ISO/DS7198.

Radial Tensile Strength (RTS): Radial tensile testing was performed to standard operating procedures on an Instron tensile testing machine 1011. The test piece was 12±0.5 mm and was threaded over a split pin assembly and loaded into the Instron machine where jaw separation was at 50 mm/min using the ASTM 1708 method and the international standards organization certification standard ISO 527. The extension and peak load was recorded and load at break calculated from the following equation:

Load per unit length=Maximum Load/2×Length of Sample

This resulted in stress-strain curves.

Results

Characterisation of Internal and External Surfaces of Heparin Bonded CPU by XPS

TABLE 2
Surface chemical compositions (figures are in atomic %)

| Sample | Surface | Area | C | O | N | S | Na | Si | Cl | P | Ca |
|---|---|---|---|---|---|---|---|---|---|---|---|
| Description | | | | | | | | | | | |
| Heparin | — | — | 39.6 | 44.5 | 2.2 | 5.2 | 8.5 | — | — | — | — |
| Powder | | | | | | | | | | | |
| Reference | | | | | | | | | | | |
| Heparin | — | — | 34.0 | 54.0 | 3.0 | 9.0 | — | — | — | — | — |
| (theoretical)(2) | | | | | | | | | | | |
| Non-coated | internal | 1 | 71.6 | 24.8 | 1.2 | — | — | 2.4 | — | — | — |
| MyoLink graft | | | | | | | | | | | |
| Non-coated | internal | 2 | 72.5 | 23.8 | 1.6 | — | — | 2.0 | tr. | — | — |
| MyoLink graft | | | | | | | | | | | |
| Non-coated | internal | 3 | 71.0 | 24.8 | 1.6 | — | — | 2.5 | 0.1 | — | — |
| MyoLink graft | | | | | | | | | | | |
| Non-coated | external | 1 | 84.5 | 10.6 | 4.0 | — | — | 0.8 | 0.1 | — | — |
| MyoLink graft | | | | | | | | | | | |
| Non-coated | external | 2 | 81.7 | 12.9 | 4.6 | — | — | 0.8 | — | — | — |
| MyoLink graft | | | | | | | | | | | |
| Non-coated | external | 3 | 84.1 | 11.9 | 2.5 | — | — | 1.5 | tr. | — | — |
| MyoLink graft | | | | | | | | | | | |
| Heparin coated | internal | 1 | 70.2 | 24.9 | 1.1 | 0.5 | 0.1 | 2.3 | — | — | 0.1 |
| MyoLink graft | | | | | | | | | | | |
| Heparin coated | internal | 2 | 68.9 | 25.0 | 1.2 | 0.3 | 1.0 | 2.6 | — | — | — |
| MyoLink graft | | | | | | | | | | | |
| Heparin coated | internal | 3 | 72.0 | 23.4 | 1.8 | 0.2 | — | 1.9 | — | 0.2 | |
| MyoLink graft | | | | | | | | | | | |
| Heparin coated | external | 1 | 74.3 | 21.0 | 1.5 | 0.3 | 0.3 | 1.7 | 0.1 | 0.1 | 0.2 |
| MyoLink graft | | | | | | | | | | | |
| Heparin coated | external | 2 | 74.6 | 20.9 | 1.1 | tr. | 0.4 | 1.8 | — | 0.2 | — |
| MyoLink graft | | | | | | | | | | | |
| Heparin coated | external | 3 | 74.3 | 20.3 | 1.6 | tr. | 0.4 | 2.4 | — | 0.1 | — |
| MyoLink graft | | | | | | | | | | | |

TABLE 3
Summary of carbon 1s spectra (figures are in % of total carbon concentration)

| | | | | C═O | | |
|---|---|---|---|---|---|---|
| | | C—C | C—O | O—C—O | | |
| Sample Description | Surface | C—H | C—N | N—C═O | O—C═O | CO₃ |
| Chemical Group | | Hydro- | ether/ | carbonyl/ | carboxyl | carbonate |
| | | carbon | hydroxyl/ | aminde | | |
| | | | amine | | | |
| (˜binding energy,eV) | | 285.0 | 286.5 | 288 | 289 | 290.3 |
| Heparin Powder Ref. | — | 24 | 52 | 20 | 4 | — |
| Heparin | — | 8 | 62 | 15 | 15 | — |
| (theoretical) (2) | | | | | | |
| Non-coated | internal | 58 | 32 | 3 | 1 | 5 |
| MyoLink graft | | | | | | |
| Non-coated | external | 79 | 14 | 6 | 1 | — |
| MyoLink graft | | | | | | |
| Heparin coated | internal | 65 | 26 | 5 | 2 | 2 |
| MyoLink graft | | | | | | |
| Heparin coated | external | 70 | 21 | 4 | 3 | 2 |
| MyoLink graft | | | | | | |

TABLE 4
Summary of nitrogen spectra
(figures are in % total nitrogen concentration)

| | | amine/ | H₃CN⁺ | R₄N⁺ |
|---|---|---|---|---|
| | | amide | ammo- | quaternary |
| Sample Description | Surface | N—S | nium ion | nitrogen |
| (˜binding energy, eV) | | ˜399.8 | ˜401.5 | ˜402.3 |
| Heparin Powder Ref. | — | 88 | 12 | — |
| Non-coated MyoLink graft | internal | 88 | 12 | — |
| Non-coated MyoLink graft | external | 86 | 9 | 4 |
| Heparin coated MyoLink graft | internal | 64 | 13 | 23 |
| Heparin coated MyoLink graft | external | 76 | 11 | 13 |

TABLE 5
Summary of sulfur spectra
(figures are in % of total sulfur concentration)

| | | NSO₃ | OSO₃ |
|---|---|---|---|
| Sample Description | Surface | sulphonamide | sulphonate |
| Binding energy eV; 2p_{3/2} | | 168.0 | 169.0 |
| Heparin Powder Reference | — | 30 | 70 |
| Binding energy eV; 2p_{3/2} | | 167.4 | 168.6 |
| Heparin coated MyoLink agraft | internal | 37 | 63 |

Surface Composition

The following species are identified the XPS analysis of the heparin coated MyoLink graft.

1. Heparin The heparin concentration can be directly determined by XPS

2. Quaternary nitrogen Possibly originating from the spacer group

3. Carbamate Originating from poly(carbonate-urea)urethane

4. Carbonate Originating from poly(carbonate-urea)urethane

5. Silicon Originating from silicone (PDMS) applied as a lubricant during the extrusion stage of the MyoLink graft manufacture prior to coating.

TABLE 6
Heparin Surface Concentration

| Sample Description | Surface | Area | N | S |
|---|---|---|---|---|
| Heparin Powder Reference | — | — | 2.2 | 5.2 |
| Heparin (theoretical) (2) | — | — | 3.0 | 9.0 |
| Heparin coated MyoLink graft | internal | 1 | 1.1 | 0.5 |
| Heparin coated MyoLink graft | internal | 2 | 1.2 | 0.3 |
| Heparin coated MyoLink graft | internal | 3 | 1.8 | 0.2 |
| Heparin coated MyoLink graft | external | 1 | 1.5 | 0.3 |
| Heparin coated MyoLink graft | external | 2 | 1.1 | tr. |
| Heparin coated MyoLink graft | external | 3 | 1.6 | tr. |

Heparin surface concentrations are quantified by the percent sulphur on the coated surfaces, with reference to the pure heparin sample.

Internal Surface

The results in Table 11 indicate that the heparin surface concentration ranges between 4 percent and 10 percent of the surface.

External Surface

The results in the Table 11 indicate that the heparin surface concentration ranges between less than 2 percent and 6 percent of the surface.

Heparin Bioactivity and Sulphur Binding Energy

The two chemical states of sulphur in heparin can be resolved into four spin-split states in XPS using instruments that possess an X-ray monochromator. The binding energies of the S2p_{3/2} states were investigated previously for the degree of ionic-covalent bonding of the heparin which influences the bioactivity of the coating with covalent bonding being more bioactive than ionic bonding. Sulphur states detected were as follows:

TABLE 7
Summary of sulfur spectra

| Sample Description | Surface | NSO₃ | OSO₃ |
|---|---|---|---|
| Binding energy eV; 2p_{3/2} | | 168.0 | 169.0 |
| Heparin Powder Reference | — | 30 | 70 |
| Binding energy eV; 2p_{3/2} | | 167.4 | 168.6 |
| Heparin coated MyoLink graft | internal | 37 | 63 |
| Binding energy eB; 2p_{3/2} | | 167.7 | 168.5 |
| Pure Heparin (Ref. (2)) | — | 33 | 67 |
| Binding energy eV; 2p_{3/2} | | 167.7 | 168.5 |
| Covalently bound Heparin (Ref.(2)) | — | 21 | 79 |

These ratios indicate that the heparin attached to the spacer group on the MyoLink graft is covalently bound. Further evidence for the binding can be determined from the heparin sulphonamide group nitrogen in comparison with reference data.

Nitrogen Binding Energy

The XPS peak binding energies of the nitrogen in the sulphonamide groups on the heparin chain can provide information on the nature of the binding of the heparin to the spacer group. Comparison of the binding energies is presented in Table 8.

Summary of Heparin Sulphonamide Nitrogen Spectra: Table 8

| Sample Description | Source | Binding energy of NSO₃ (eV) |
|---|---|---|
| Heparin Powder Reference | this work | 399.6 |
| Covalently attached heparin | (2) | 399.7 |
| Ionically attached heparin | (2) | 399.4 |
| Heparin coated MyoLink graft | this work | 400.0 |

The binding energy of the heparin on the MyoLink coating is closer to the preferred covalent coating and further from (deactivated) ionic coatings. The binding energy value for the heparin on MyoLink may indicate that its bioactivity (per unit of heparin) is higher than that of the covalently attached heparin which has previously been investigated.

Summary of Results:

Heparin was detected at all points analysed on the inner lumen of the heparin coated Myolink graft.

Heparin distribution was uniform between the points analysed. The heparin concentrations ranged from 4 to 10 percent on the inner lumen and these values can be compared with heparin concentrations of 30 percent for other coatings analysed previously. The slightly lower concentration is due to the sample having been perfused in a physiological in vitro circuit.

No degradation of the CPU structure after the coating treatment could be detected by XPS.

Heparin bioactivity per unit heparin would be expected to be as good as, if not better than, the covalently attached heparin investigated previously.

Intermediate manufacturing processes have resulted in silicone (PDMS) remaining in the final heparin coated product at low levels. No heavy metals could be detected by XPS in these samples such as ruthenium present from the bonding process itself.

Characterisation of Heparin/RGD Coated CPU Material by XPS

TABLE 9
Surface chemical compositions (figures are in atomic %)

| Sample Description | Surface | Area | C | O | N | S | Na | Si | P | Ca |
|---|---|---|---|---|---|---|---|---|---|---|
| Heparin RGD coated | internal | 1 | 72.0 | 22.8 | 1.7 | 0.6 | — | 3.0 | — | — |
| MyoLink | | | | | | | | | | |
| Heparin RGD coated | internal | 2 | 70.9 | 23.5 | 2.6 | 0.2 | — | 2.8 | — | — |
| MyoLink | | | | | | | | | | |
| Heparin RGD coated | internal | 3 | 73.5 | 22.0 | 1.9 | 0.4 | — | 2.2 | — | — |
| MyoLink | | | | | | | | | | |

TABLE 10
Summary of carbon is spectra (figures are in % of total carbon concentration)

| | | C—C | | | O—C—O | | |
|---|---|---|---|---|---|---|---|
| Sample Description | Surface | C—H | C—N | C—O | N—C═O | O—C═O | CO₃ |
| (˜binding energy, eV) | | 285.0 | 285.9 | 286.8 | 288 | 289 | 290.3 |
| Heparin RGD coated | internal | 60 | 5 | 26 | 1 | 2 | 6 |
| MyoLink | | | | | | | |
| Heparin RGD coated | internal | 64 | 3 | 23 | 1 | 2 | 6 |
| MyoLink | | | | | | | |

TABLE 11
Summary of nitrogen spectra (figures are in % of total nitrogen concentration)

| | | secondary | amine/ | | |
|---|---|---|---|---|---|
| | | amine | amide | | |
| Sample Description | Surface | R₂NH | N—S | H₃CN⁺ | R₄N⁺ |
| (˜binding energy, eV) | | ˜399.0 | ˜400.1 | ˜401.5 | ˜402.3 |
| Heparin RGD coated MyoLink | internal | 9 | 79 | 4 | 10 |
| Heparin RGD coated MyoLink | internal | 18 | 65 | 9 | 8 |

TABLE 12
Summary of sulfur spectra
(figures are in % of total sulfur concentration)

| Sample Description | Surface | NSO₃ | OSO₃ |
|---|---|---|---|
| (Binding energy, eV; 2p(3/2)) | | 167.4 | 168.6 |
| Heparin RGD coated MyoLink | internal | 16 | 84 |
| Heparin RGD coated MyoLink | internal | 42 | 58 |

The presence of heparin on the inside lumen of the heparin RGD graft is confirmed by the following factors:

1. Sulfur is detected at all points analysed, along with nitrogen, carbon and oxygen as expected from heparin and the other components present including RGD.

2. Sulfur is present in two states at all points analysed, namely NSO₃ and OSO₃. Some of the OSO₃ detected by XPS may originate from other OSO₃-containing species such as sulfonates but the NSO₃ signal originates solely from the heparin grafted to the surface.

3. Nitrogen is detected in four states in the heparin-coated RGD surface. Three of the four states were also observed in the Heparin coated surface analysed previously (see above analysis).

4. Carbon in both C—O and to a much lesser extent O—C—O states was detected on all the surfaces analysed.

All four characteristics confirm that heparin is present on all the inner lumen surfaces analysed on the sample of heparin-RGD coated graft. It is quite clear from the spectra obtained that the polymer surface in this case MyoLink does not appear to be modified during the bonding process.

The presence of the RGD amino acid sequence is indicated in the XPS spectrum by the new state of nitrogen detected in this sample at a binding energy of 399 eV. This is proposed to be the secondary amine state of RGD, which is not present in either heparin or MyoLink structures.

The RGD concentration is high and correlates directly with the heparin concentrations at each point.

Assessment of Degradation of Polymer After Bonding

ESEM Analysis

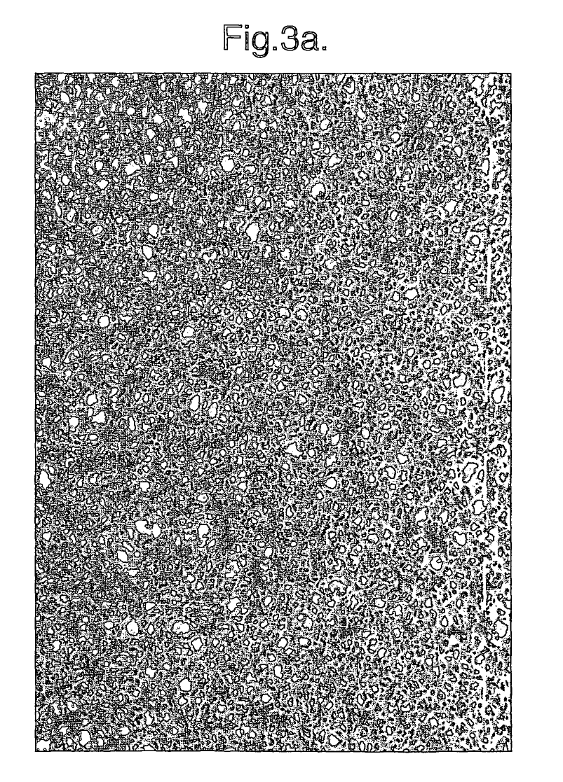

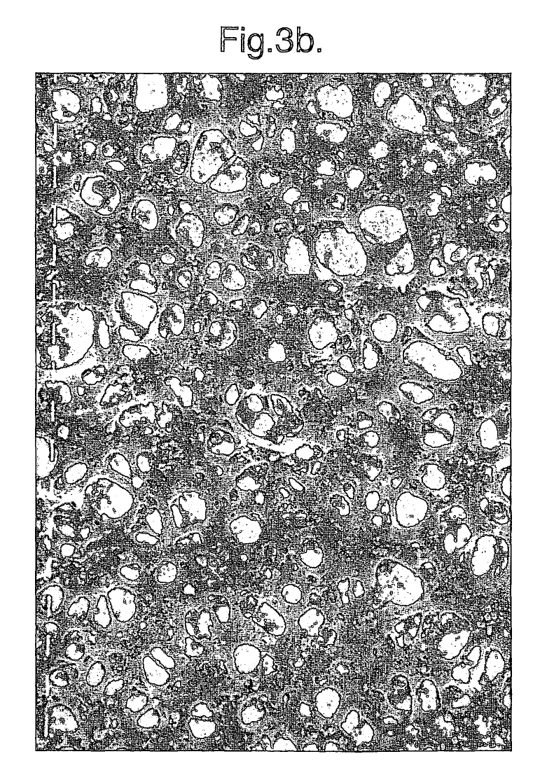

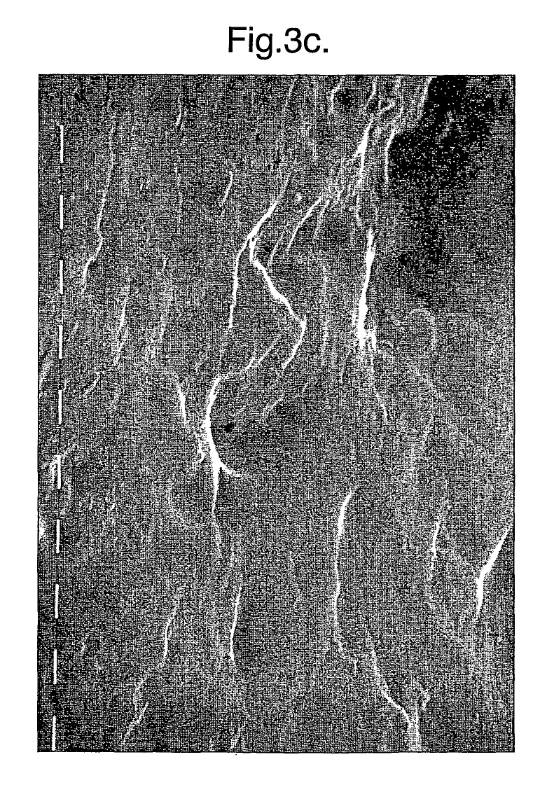

ESEM analysis of graft coated with RGD and heparin show at low and high magnifications that there is no evidence of degradation post bonding (FIGS. 3a,b,c measured at a: mag×55, b: mag×220, and c: mag×3500). This was ascertained as there was no visible presence of pitting or etching, common characteristics of ESC.

DSC

No changes in glass transition temperature or endotherms indicative of degradation were evident.

TMA

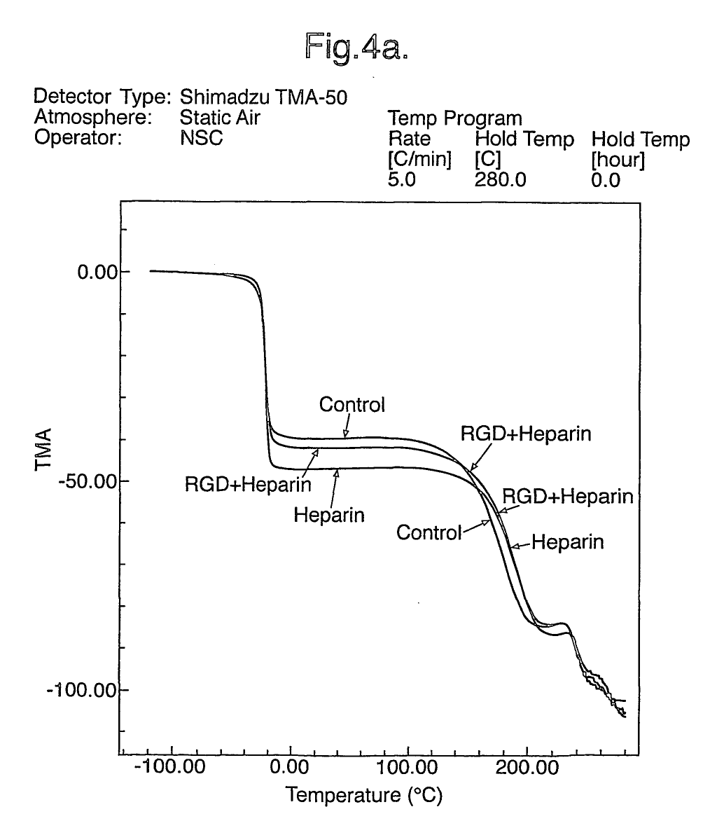

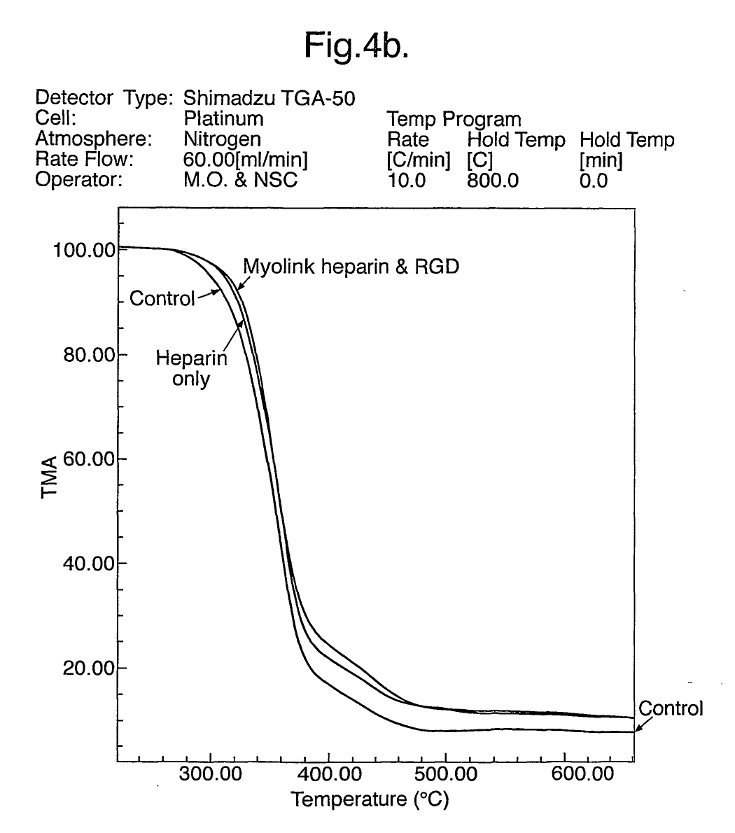

FIGS. 4a,b showed that like native CPU there was no degradation as evidenced by a lack of peaks from −100 to 50 C. Previous in vitro and in vivo degradation studies have shown that if the carbonate linkage degrades, numerous large and sharp peaks are evidenced in this region.

DMA

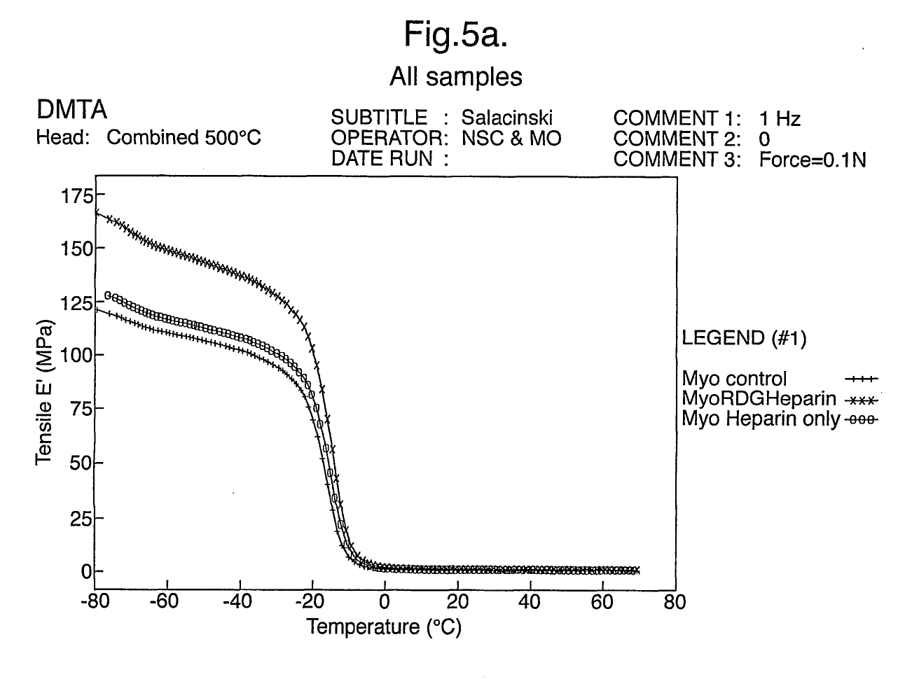

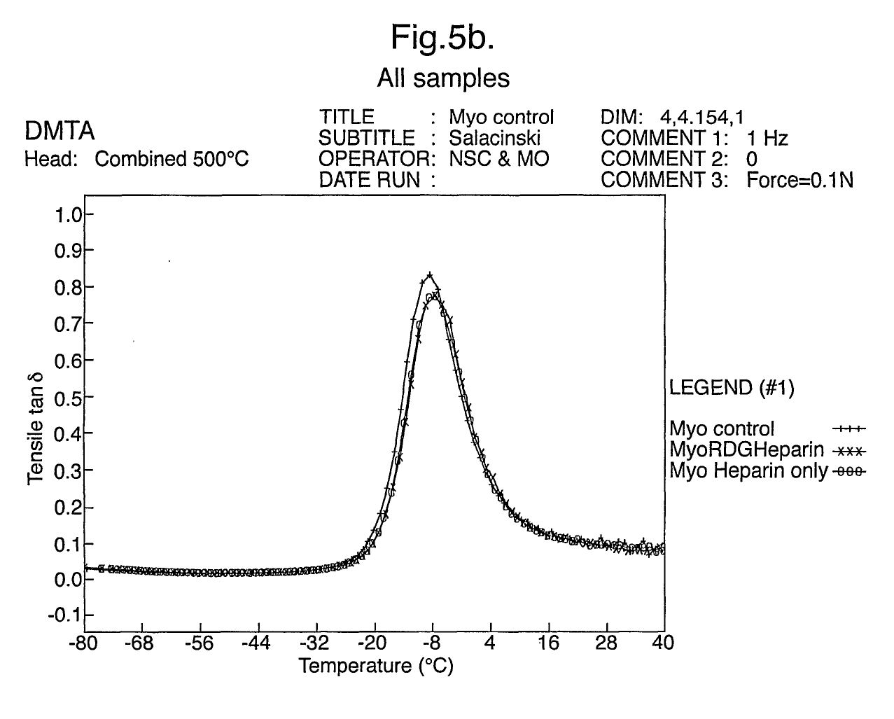

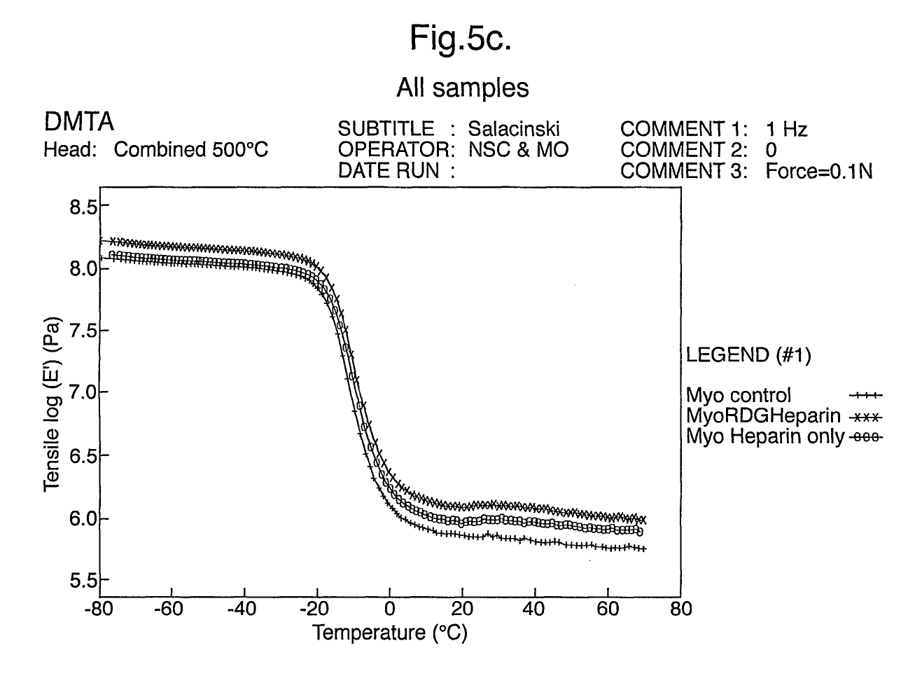

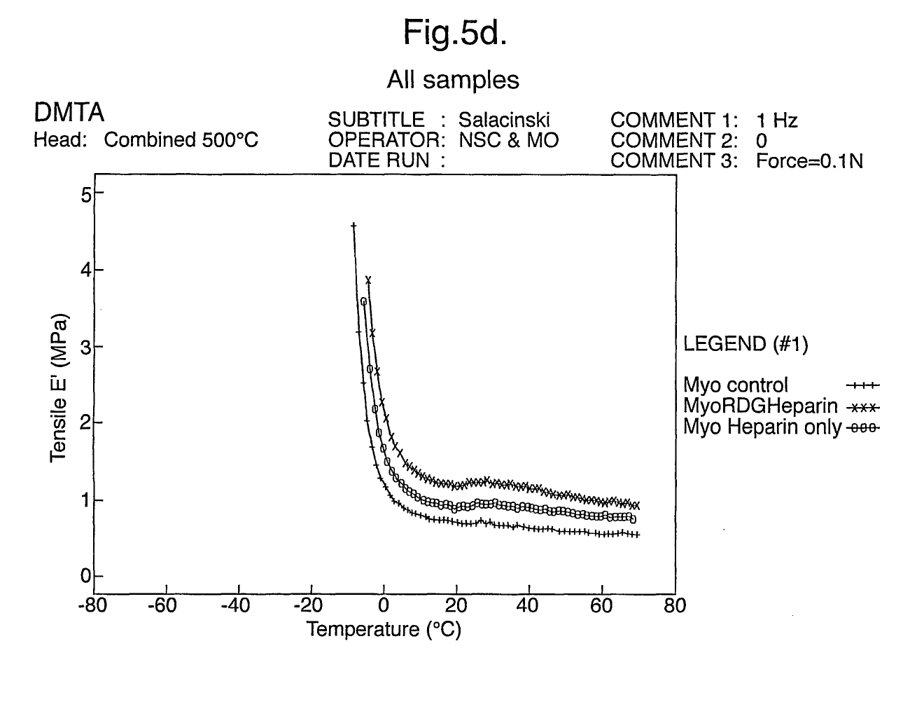

FIGS. 5a,b,c,d showed as above no evidence of degradation as no P peak is present. Indeed it shows as the CPU material is cross-linked by heparin or heparin and RGD it in fact becomes slightly more rigid reducing any inherent energy mismatches stabilising the internal structure and thus making it less degradible.

Quality Control

Quality control showed that the internal diameter of vascular graft (polymer) had not changed since it remained 5 mm±0.1 mm, wall thickness, 0.9 mm±0.05 mm, and visually free from defects so that the dimensions and appearance remained in normal batch release limits (n=6).

Radial tensile strength was assessed on the polymer grafts post bonding to standard operating procedures on an Instron tensile testing machine 1011 and remained at 1.48 N/mm so this indicated that the samples (n=6) remained within the batch tolerances which is greater than 1 N/mm.

GPC Analysis

GPC analysis showed that no significant difference was found between the control (mw 98500, mn 45300, d 2.17) and test samples (mw 10400, mn 41600, d 2.495)

### Example 7

### In Vivo Tests

Prostheses composed of the lined polymers of the invention can be further tested in vivo by inserting them into a surgical subject by known techniques, e.g. by carrying out bypass or other operations, and monitoring their performance, optionally by removing and analysing them after a predetermined period of time. The subject is likely to be a mouse or other non-human mammal test subject in the first instance but clinical trials on human patients can also be envisaged.

Similar in vivo tests can be envisaged for heart valves and other prostheses, as well as for non-prosthetic surgical apparatus, e.g. cannulas and tubing, comprising the lined polymers of the invention.

1. Process for producing an activated polymer, which process comprises bonding a spacer arm to a polymer, characterised in that the process is conducted in the presence of a metallocene-type compound.

2. In a process for producing an activated polymer, which process comprises bonding a spacer arm to a polymer, the improvement of conducting said reaction in the presence of a metallocene-type compound.

3. Process for catalysing a reaction using a metallocene-type compound, characterised in that the reaction comprises bonding a spacer arm to a polymer.

4. In a process for catalysing a reaction using a metallocene-type compound, the improvement of the reaction comprising bonding a spacer arm to a polymer.

5. A process according to any one of the preceding claims wherein the metallocene-type compound is either a compound of formula:
M(Cp)L2(Hal) (I)
wherein Cp is a cyclopentadienyl ligand which is unsubstituted or substituted by one or more substituents selected from halogen, hydroxy, nitro, C₁₋₆ alkyl C₂₋₆ alkenyl, C₁₋₆ alkoxy, C₆₋₁₀ aryl, C₁₋₆ alkyl-C₆₋₁₀ aryl, C₂₋₆ alkenyl-C₆₋₁₀ aryl, —NR¹R², wherein R¹ and R² may be identical or different and are selected from hydrogen and a C₁₋₆ alkyl group, —COR³ and —COOR³ wherein R³ is hydrogen or a C₁₋₆ alkyl group;
M is ruthenium or osmium;
Hal is fluorine, chlorine, bromine or iodine;
the groups L may be identical or different and are selected from a C₁₋₆ alkyl group, CO and PR₃, wherein at least one L is PR₃;
the groups R may be identical or different and each is selected from hydrogen, a C₁₋₆ alkyl group and an aryl group Ar which is a C₆₋₁₀ aryl group or a heteroaryl group, the heteroaryl group being a 5- or 6-membered ring containing at least one heteroatom selected from nitrogen, oxygen and sulfur, and wherein each R is unsubstituted or substituted by one or more substituents which may be identical or different, each being selected from halogen, hydroxy, nitro, C₁₋₆ alkyl, C₁₋₆ alkenyl, C₁₋₆ alkoxy, —NR¹R², wherein R¹ and R² may be identical or different and are selected from hydrogen and a C₁₋₆ alkyl group, —COR³ and —COOR³ wherein R³ is hydrogen or a C₁₋₆ alkyl group;
or a compound of formula:
M(Cp)₂ (II)
wherein M is as defined above and the groups Cp may be identical or different and are as defined above.

6. Process according to claim 5, wherein the metallocene-type compound is a compound of formula (I) wherein Cp is an unsubstituted cyclopentadienyl group, the groups L are both PR₃ groups which may be identical or different, and each is represented by the formulae PR′₃, PR′₂ Ar, PR′Ar₂, or PAr₃, wherein the groups R′ may be identical or different, and each is a C₁₋₆ alkyl group and each Ar, which may be identical or different, represents a phenyl, naphthyl or pyridyl group, each R′ and Ar being unsubstituted or substituted by one or more substituents selected from halogen, hydroxy, nitro, C₁₋₆ alkyl, C₂₋₆ alkenyl, C₁₋₆ alkoxy, —NR¹R², wherein R¹ and R² may be identical or different and are selected from hydrogen and a C₁₋₆ alkyl group, —COR³ and —COOR³ wherein R³ is hydrogen or a C₁₋₆ alkyl group.

7. Process according to claim 6, wherein Ar is phenyl and R′ is methyl.

8. Process according to claim 7, wherein the metallocene-type compound is Ru(cyclopentadienyl)(PPh₃)₂Cl.

9. Process according to any one of the preceding claims, wherein the polymer is polytetrafluoroethylene, Dacron or poly(carbonate-urea)urethane.

10. Process according to any one of the preceding claims, wherein the polymer is in the form of a prosthesis.

11. Process according to any one of claims 1 to 9, further comprising the step of forming a prosthesis from the activated polymer.

12. Process according to any one of the preceding claims, further comprising reacting the activated polymer with a lining substance to produce a lined polymer.

13. Process according to claim 12, wherein the lining substance comprises a peptide.

14. Process according to claim 13, wherein the peptide is an anticoagulant peptide and/or a growth peptide and/or a chemotactic peptide.

15. Process according to any one of claims 12 to 14, wherein the lining substance comprises a seed cell, such that the activated polymer is seeded with a lining of seed cells.

16. Process according to any one of claims 12 to 15, wherein the lined polymer is reacted with 1-ethyl-3(3-dimethylaminopropyl)carbodiimide prior to reaction with the activated polymer.

17. Process according to any one of claims 12 to 16, further comprising the step of forming a prosthesis from the lined polymer.

18. Process according to any one of claims 10 to 17, wherein the prosthesis is a vascular graft.

19. Process according to claim 18, wherein the graft is a poly(carbonate-urea)urethane graft.

20. An activated polymer, lined polymer or prosthesis obtainable by the process of any one of claims 1 to 19.

21. An activated polymer, lined polymer or prosthesis obtained by the process of any one of claims 1 to 19.

22. A method of treating a human or animal subject in need of the replacement of a body part, said method comprising replacing said body part with the prosthesis of claim 20 or 21.

23. Use of a catalyst which comprises a metallocene-type compound as defined in any one of claims 1 to 8, in bonding spacer arms to a polymer suitable for use as a prosthesis.

24. Use of a metallocene-type compound as defined in any one of claims 1 to 8, a spacer arm and a polymer suitable for use as a prosthesis, in the manufacture of a prosthesis for the replacement of a body part.

25. A metallocene-type compound as defined in any one of claims 1 to 8 having the space group P21/n.

26. Ru(cyclopentadienyl)(PPh₃)₂Cl having the structure set out in FIG. 1, and having the bond lengths:
Ru(1)-P(2)-2.3202 Å
Ru(1)-P(1)=2.3212 Å
Ru(1)-Cl(1)=2.451 Å
Ru(1)-C(0)=1.8417 Å
and having the bond angles:
Cl(1)-Ru(1)—C(O)=121.50°
P(2)-Ru(1)-P(1)=101.57°
P(2)-Ru(1)-Cl(1)=90.24°
P(1)-Ru(1)-Cl(1)=91.70°
P(1)-Ru(1)-C(0)=121.51°
P(2)-Ru(1)-C(O)=122.33°.
wherein C(0) represents the centre of gravity of the cyclopentadienyl ring.

27. A process for producing a compound of formula:
M(Cp)(PR₃)₂Hal (III)
wherein M, Cp, PR₃ and Hal are as defined in any one of claims 5 to 8 and wherein the groups PR₃ are identical or different, or a compound as defined in claim 25 or 26, which process comprises reacting from 1.8 to 2.5 parts by mole of PR₃ with 0.8 to 1.5 parts by mole of Ru(Hal)₃ and 0.8 to 1.5 parts by mole of cyclopentadiene in dry diethyl ether.

28. A compound as defined in claim 26, which compound is obtainable by the process of claim 27.

29. A compound as defined in claim 26, which compound is obtained by the process of claim 27.
